(19) United States
(12) Patent Application Publication
(10) Pub. No.: US 2014/0185216 A1
(43) Pub. Date: Jul. 3, 2014

(54) KEYBOARD ASSEMBLY WITH CABLE LATCHING STRUCTURE

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: XIANG-KUN ZENG, Shenzhen (CN); RUN LONG, Shenzhen (CN); CHENG HAO, Shenzhen (CN); DONG-XU TAN, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/021,778

(22) Filed: Sep. 9, 2013

(30) Foreign Application Priority Data
Dec. 28, 2012 (CN) 2012105827346

(51) Int. Cl. G06F 1/16

(52) U.S. Cl. CPC G06F 1/16
USPC 361/679.08

(57) ABSTRACT

A keyboard assembly includes a keyboard, two latching structures, and a data cable. The keyboard includes a bottom plate. Each latching structure is located on the bottom plate and includes a positioning post and a latching strip. The positioning post is located on the bottom plate, and the latching strip extends from the positioning post. The data cable is wrapped around the positioning posts to prevent the data cable from extending too long out of the keyboard.

### BACKGROUND

1. Technical Field

The present disclosure relates to keyboard assemblies, and more particularly to a keyboard assembly with a cable latching structure.

2. Description of Related Art

A notebook computer can include an external keyboard attached to the computer by a cable. However, sometimes the cable is too long and easily tangles with other cables attached to the computer.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a keyboard assembly in accordance with an embodiment.

FIG. 2 is an enlarged view of a circled portion II of FIG. 1.

FIG. 3 is an assembled view of the keyboard assembly of FIG. 1.

FIG. 4 is an enlarged view of a circled portion IV of FIG. 3.

FIG. 5 is a top elevational view of the keyboard assembly of FIG. 3.

FIG. 6 is another assembled view of FIG. 3, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

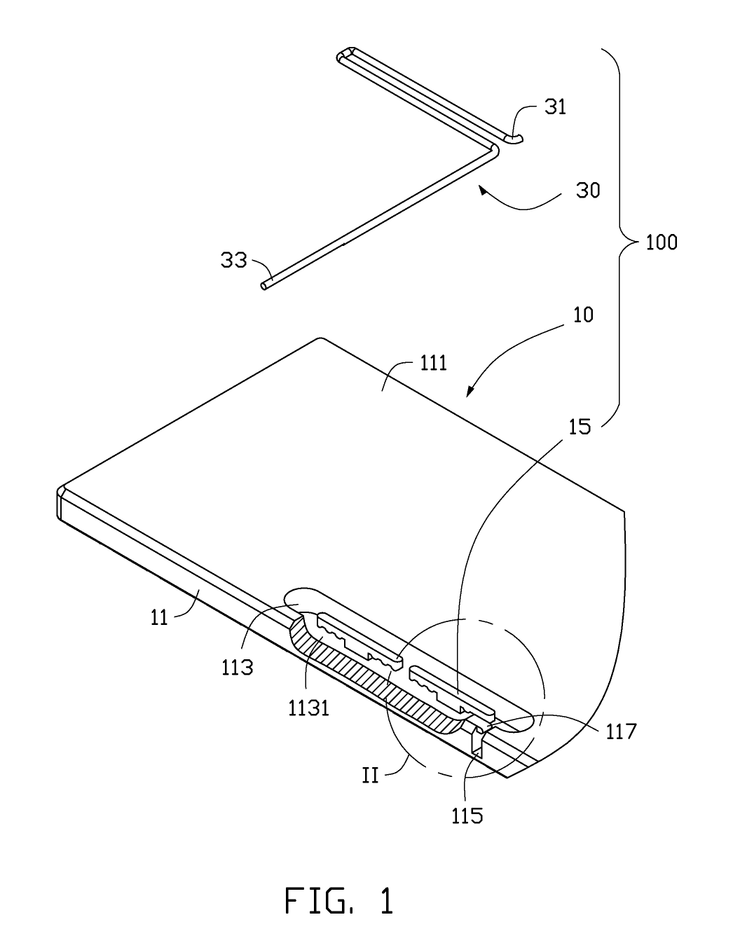

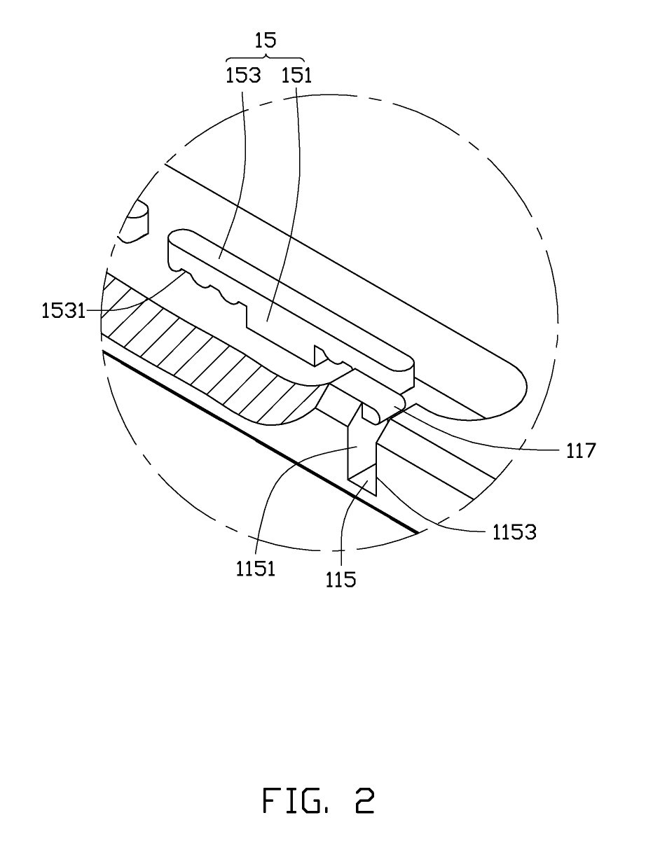

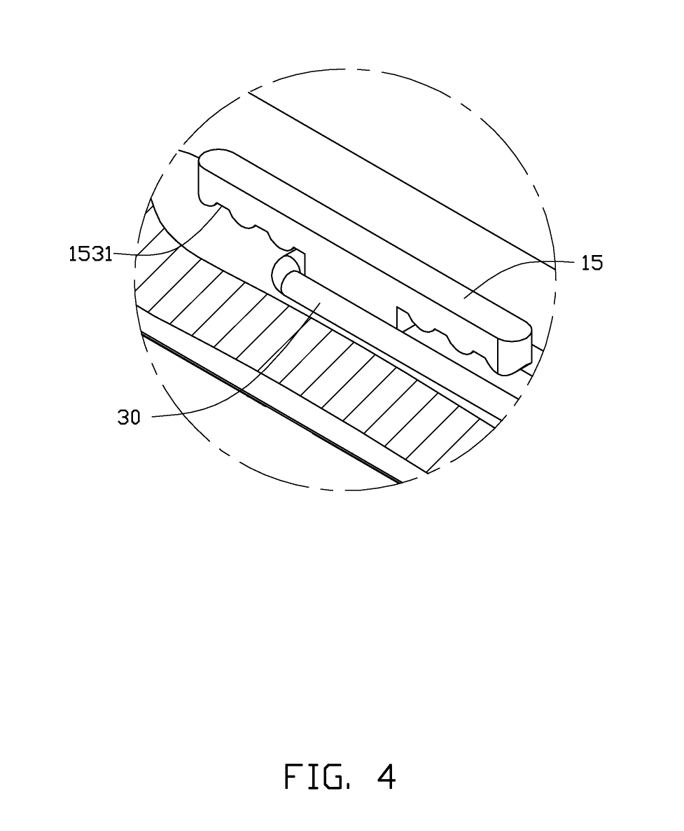

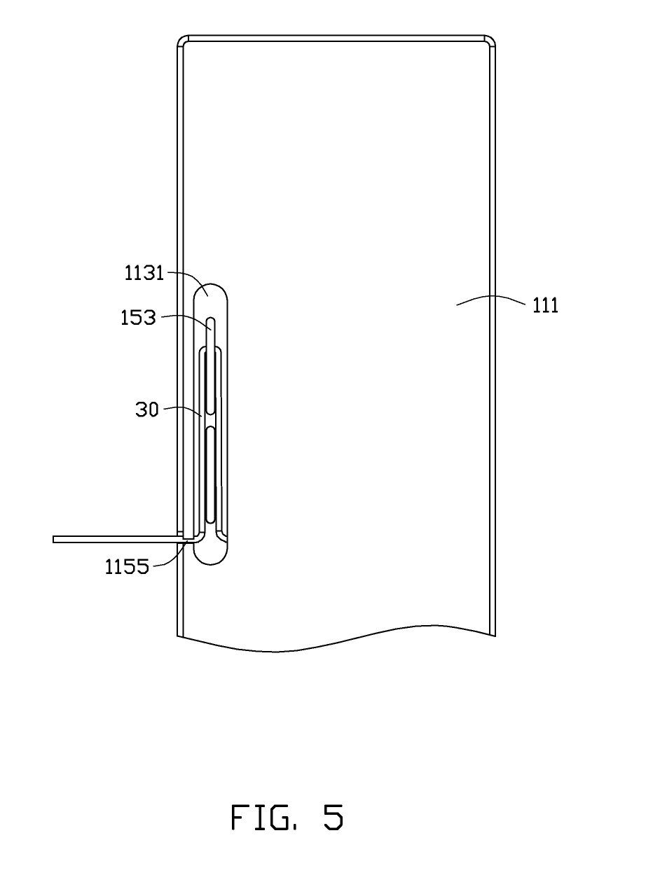

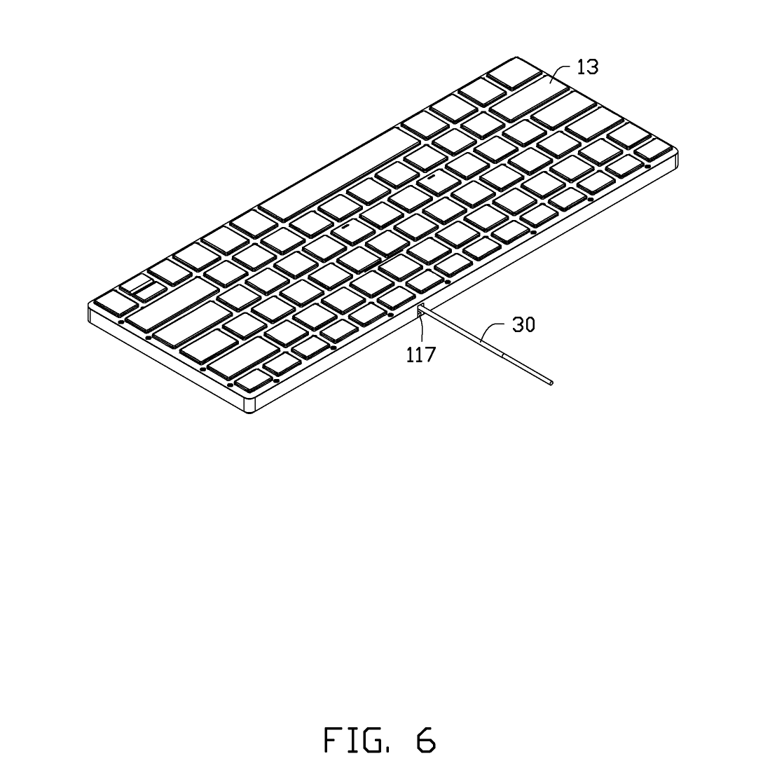

Referring to FIGS. 1-6, a keyboard assembly 100 includes a keyboard 10, a data cable 30 connected to the keyboard 10, and two latching structures 15 located on the keyboard 10. The data cable 30 includes a first end 31 and a second end 33 opposite to the first end 31. In this embodiment, the first end 31 is connected to the keyboard 10, and the second end 33 is connected to a computer. In other embodiments, the first end 31 can be connected to a mouse, a hard disk drive, and so on.

The keyboard 10 includes a base 11 and a plurality of keys 13 located on the base 11. The base 11 includes a bottom plate 111. The bottom plate 111 defines an elongated slot 113 and a cutout 115 communicating with the slot 113. The cutout 115 is defined at one end of the elongated slot 113.

A blocking tab 117 is located on the bottom plate 111. The blocking tab 117 extends from a first sidewall 1151 of the cutout 115 towards a second sidewall 1153 of the cutout 115. The first sidewall 1151 and the second sidewall 1153 are substantially parallel to each other. A slit 1155 is defined between the blocking tab 117 and the second sidewall 1153. The slit 1155 communicates with the cutout 115 and the elongated slot 113, for holding the data cable 30.

The two latching structures 15 are accommodated in the elongated slot 113 and are arranged in a line that is substantially parallel to the bottom plate 111. Each of the two latching structures 15 includes a positioning post 151 and a latching strip 153 located on the positioning post 151. The positioning post 151 has an extension direction that is substantially perpendicular to the bottom plate 111. In one embodiment, the positioning post 151 has a height that is slightly smaller than a depth of the elongated slot 113. The latching strip 153 extends from the positioning post 151 and has a first extension direction that is perpendicular to the extension direction of the positioning post 151, and a second extension direction opposite to the first extension direction. The latching strip 153 defines a plurality of latching grooves 1531. Each of the two latching structures is substantially T-shaped.

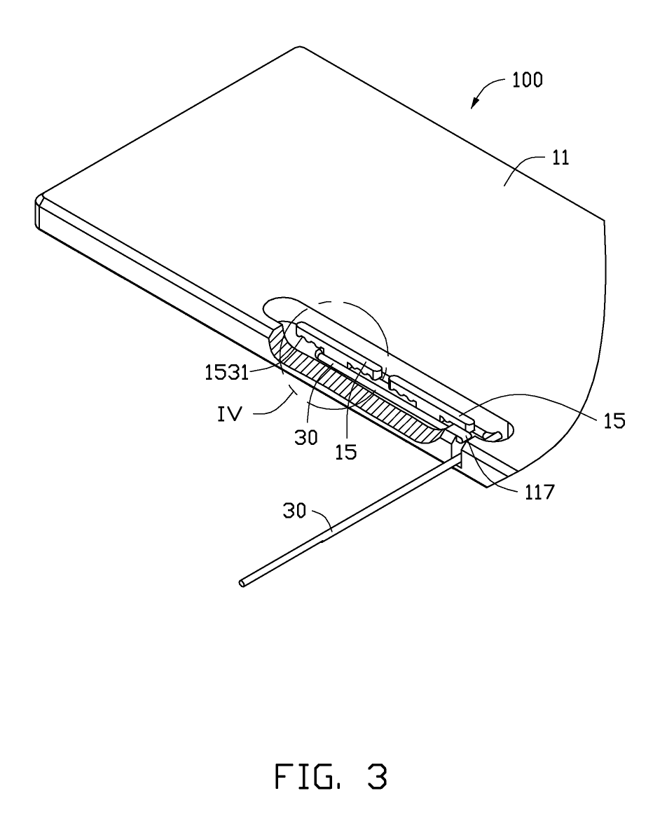

FIGS. 3-6 show that in assembly, the data cable 30 is wrapped around the positioning posts 151 of the two latching structures 15 to be located between the plurality of grooves 1531 and the elongated slot 113. The latching strips 153 are resilient and can be lifted to insert the cable 30 under the plurality of grooves 1531. The second end 33 extends through the cutout 115 to be exposed out of the keyboard 10. Thus, the data cable 30 has a proper length outside the keyboard to prevent the data cable 30 from tangling with other cables.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A keyboard assembly comprising:
a keyboard comprising a bottom plate;
a latching structure located on the bottom plate and comprising a positioning post and a latching strip; and the positioning post being located on the bottom plate, and the latching strip extends from the positioning post; and
a data cable surrounding the positioning post and engaged between the latching strip and the bottom plate, to prevent the data cable from disengaging from the positioning post.

2. The keyboard assembly of claim 1, wherein the bottom plate defines an elongated slot; and the latching structure is located a bottom wall of the elongated slot.

3. The keyboard assembly of claim 2, wherein the positioning post height is slightly smaller than the elongate slot depth.

4. The keyboard assembly of claim 1, wherein the positioning post has an extension direction that is substantially perpendicular to the bottom plate.

5. The keyboard assembly of claim 4, wherein the latching strip has a first extension direction and a second extension direction opposite to the first extension direction; and the first extension direction is substantially perpendicular to the extension direction of the positioning post.

6. The keyboard assembly of claim 5, wherein the latching strip defines a plurality of latching grooves; and the data cable is received in the plurality of latching grooves.

7. The keyboard assembly of claim 2, wherein the bottom plate further defines a cutout in communication with the elongated slot, the data cable comprising a first end and a second end opposite to the first end; and the first end is connected to the keyboard, and the second end extends through the cutout to be exposed out of the keyboard.

8. The keyboard assembly of claim 7, wherein a blocking tab is located on the bottom plate and configured to prevent the data cable from disengaging from the keyboard.

9. The keyboard assembly of claim 8, wherein the blocking tab extends from a first sidewall of the cutout towards a second sidewall of the cutout.

10. The keyboard assembly of claim 1, wherein each of the two latching structures is substantially T-shaped.

11. A keyboard assembly comprising:
a keyboard comprising a bottom plate;
two latching structures located on the bottom plate, each of the two latching structures comprising a positioning post and a latching strip; the positioning post being located on the bottom plate, the latching strip extending from the positioning post; and
a data cable surrounding the positioning post of each of the two latching structures and engaged between the latching strip each of the two latching structures and the bottom plate, to prevent the data cable from disengaging from the positioning post.

12. The keyboard assembly of claim 11, wherein the bottom plate defines an elongated slot; the two latching structures are located a bottom wall of the elongated slot, and the two latching structures are arranged in a line that is substantially perpendicular to the bottom plate.

13. The keyboard assembly of claim 12, wherein the positioning post height of each of the two latching structures is slightly smaller than the elongate slot depth.

14. The keyboard assembly of claim 11, wherein the positioning post of each of the two latching structures has an extension direction that is substantially perpendicular to the bottom plate.

15. The keyboard assembly of claim 14, wherein the latching strip of each of the two latching structures has a first extension direction and a second extension direction opposite to the first extension direction; and the first extension direction is substantially perpendicular to the extension direction of the positioning post.

16. The keyboard assembly of claim 15, wherein the latching strip of each of the two latching structures defines a plurality of latching grooves; and the data cable is received in the plurality of latching grooves.

17. The keyboard assembly of claim 12, wherein the bottom plate further defines a cutout in communication with the elongated slot, the data cable comprising a first end and a second end opposite to the first end; the first end is connected to the keyboard, and the second end extends through the cutout to be exposed out of the keyboard.

18. The keyboard assembly of claim 17, wherein a blocking tab is locate on the bottom plate and configured to prevent the data cable from disengaging from the keyboard.

19. The keyboard assembly of claim 18, wherein the blocking tab extends from a first sidewall of the cutout towards a second sidewall of the cutout.

20. The keyboard assembly of claim 11, wherein each of the two latching structures is substantially T-shaped.
